(19) United States
(12) Patent Application Publication
(10) Pub. No.: US 2009/0309358 A1
(43) Pub. Date: Dec. 17, 2009

(54) AIR FLOW DUCTS

(76) Inventor: Richard Gray, Henrietta, NY (US)

Correspondence Address: Stephen B. Salai, Esq.;Harter Secrest & Emery LLP, 1600 Bausch & Lomb Place, Rochester, NY, 14604-2711, US

(21) Appl. No.: 12/138,149

(22) Filed: Jun. 12, 2008

(51) Int. Cl. F16L 23/00

(52) U.S. Cl. 285/363

(57) ABSTRACT

A duct segment includes a continuous sidewall, a plurality of flanges and an adhesive. The continuous sidewall defines a passage terminating at two opposing openings. The plurality of flanges is disposed about at least one of the openings. The flanges extend substantially perpendicularly from the sidewall and form a substantially planar mounting surface about the opening. The adhesive is applied to the mounting surface on a side of the flanges opposite the sidewall.

### BACKGROUND OF THE INVENTION

1. Field of the Invention

The present invention relates generally to duct work. More specifically, the present invention relates to a system of interconnected segmented ducts and an improved way of attaching those segmented ducts.

2. Description of Related Art

As is conventionally known in the art, duct work for use for example in residential and commercial heating and cooling systems includes a plurality of segmented ducts joined together to create a continuous duct through which air passes throughout a building structure. Duct segments generally come in standard sizes and shapes and generally consist of a continuous sidewall and openings on opposing ends. The continuous sidewall may be curved or angled, and may be square, rectangular, circular or any other cross-section. In operation, segments with cooperating ends are fitted together during installation to create a predetermined pathway.

FIG. 1 illustrates two conventional duct segments 10. As shown therein, each segment 10 includes a sidewall 12 configured to form openings 14 having generally rectangular cross-sections on opposite ends of the segment. As is generally known in the art, each segment is typically formed of a single piece of sheet metal folded along multiple fold lines 16. The openings 14 are disposed on opposite ends of the duct segments 10 such that when a plurality of duct segments 10 are fitted together, a contiguous opening is formed inside the adjacent duct segments 10. A slit or notch 18 preferably is formed proximate each open end of each duct segment 10, along fold lines 16 to create a flange 20 on each sidewall 14. As is understood by those of ordinary skill in the art, conventional duct segments are fitted together by cooperating the flanges 20 with the notches 18 such the flanges 20 overlap a portion of the sidewall 14 of the adjacent duct segment 10.

When adjacent duct segments are connected in this manner, it is also then necessary to fasten the joint in some manner. Specifically, it is not uncommon to use a collar, clips, or other removable fasteners such as, but not limited to, screws, to ensure a sturdy joint. However, these joints generally are not effective at maintaining the forced air inside the duct, i.e., without leaking through the joint. Accordingly, it is often necessary, and in some instances, required, to wrap the joint with an adhesive, such as tape or the like, to minimize the flow of air from within the duct to the exterior. As is appreciated by those in the art, this may be very difficult in some applications, particularly because ducts are typically installed near ceilings and floors, and it can be very difficult to apply tape to the seams after the ducts have been placed. Moreover, it is likely impractical to apply the tape before the ducts are in place.

Accordingly, there is a need in the art for an improved duct system that alleviates the need for wrapping of joints formed between adjacent ducts, but that maintains the flow of air within the duct system, without allowing for seepage of air at the seams.

### SUMMARY OF THE INVENTION

The present invention remedies the foregoing deficiencies in the art by providing improved air flow ducts.

In one aspect of the invention, the present invention provides a duct including a sidewall having one or more folds defining a polygonal cross-section and having opposing, open ends. A plurality of flanges is disposed about at least one of the openings. The flanges extend substantially perpendicularly from the sidewall and form a substantially planar mounting surface about the opening. An adhesive is applied to the mounting surface on a side of the flanges opposite the sidewall.

In another aspect of the invention, a duct segment for use in an air flow system includes a sidewall, at least one flange, and an adhesive. The sidewall defines an inner volume and terminates at opposing, open ends. At least one flange is associated with each of the open ends. Each flange extends substantially perpendicularly from the opposing end and has a face directed away from the sidewall. The adhesive is disposed on the face of the at least one flange associated with one of the open ends.

The duct segments may be connected by aligning flanges of adjacent ducts, and using the adhesive to adhere the face of the flange of a first duct segment to the face of a corresponding flange of the second duct segment.

An understanding of these and other features of the present invention may be had with reference to the attached figures and following description in which the invention is illustrated and described.

### BRIEF DESCRIPTION OF THE DRAWING FIGURES

FIG. 1 is a perspective view of a prior art duct assembly including two duct segments.

FIG. 2 is a perspective view of a duct segment according to a preferred embodiment of the present invention.

FIG. 3 is a plan view of a blank used for constructing a duct segment according to preferred embodiments of the invention.

FIG. 4 is an end view of a duct segment according to the present invention.

FIGS. 5A and 5B illustrate a corner piece usable in the embodiment illustrated in FIGS. 2 and 3.

FIG. 6 is a partial side elevation view of a duct system including two adjacent duct segments according to the present invention.

FIG. 7 illustrates a clip for reinforcing the attachment between adjacent duct sections.

FIG. 8 is a perspective view of a corner piece used with the other preferred embodiments of the invention.

FIG. 9 is a perspective view of another embodiment of the invention.

FIG. 10 is a perspective view of yet another embodiment of the invention.

### DETAILED DESCRIPTION OF THE INVENTION

Preferred embodiments of the invention now will be described with reference to the figures.

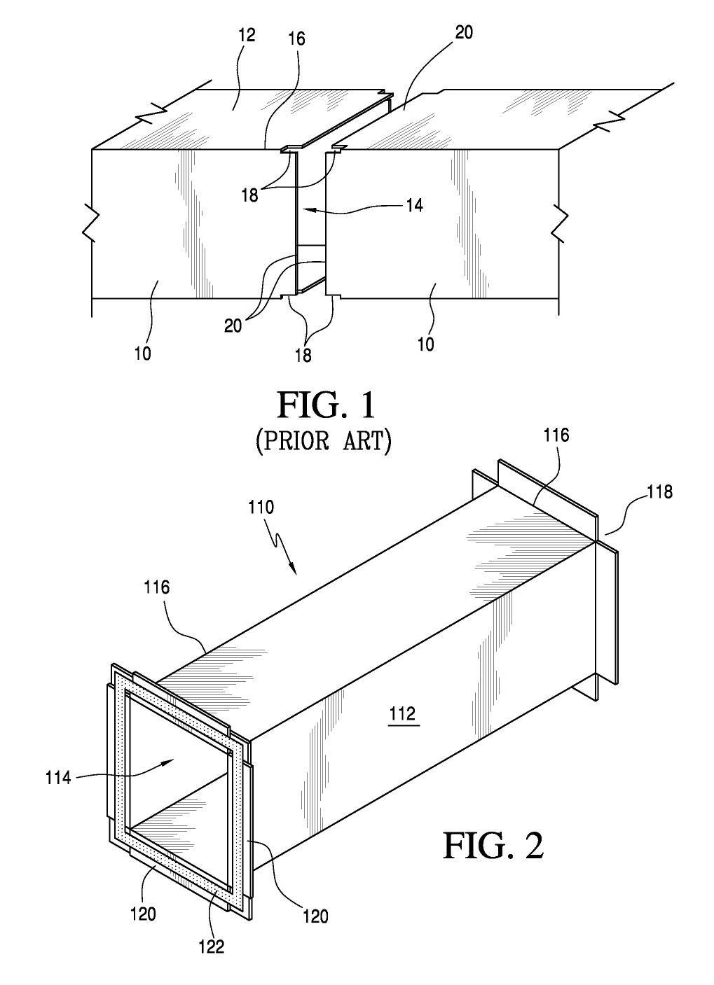

FIG. 2 generally illustrates a duct segment 110 according to a preferred embodiment of the invention. Similar to a conventional duct segment, such as that shown in FIG. 1, the duct segment of the present invention includes a continuous sidewall 112 that defines an volume having two open ends 114 through which air can enter and exit the volume. In FIG. 2, the open ends 114 are generally rectangular in cross-section, although almost any shape could be used, as would be appreciated by one of skill in the art.

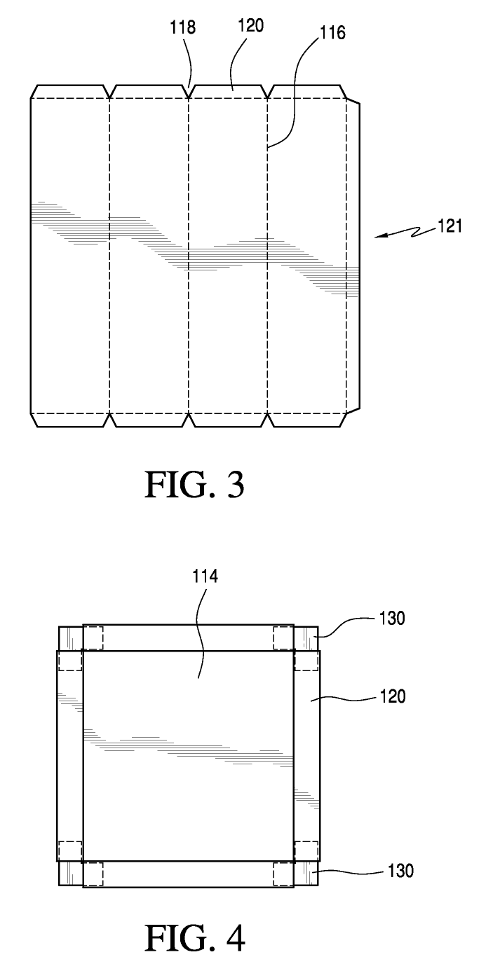

Similar to the conventional duct segments, the duct segment 110 is formed by folding a sheet metal blank 121 along fold lines 116, which form the longitudinal edges of the segment 110, when constructed. An exemplary sheet metal blank used for constructing the segment 110 is illustrated in FIG. 3. As shown therein, the fold lines are formed longitudinally (vertically as oriented in FIG. 3) to define the segments of the sidewall 112, and notches 118 are formed at the ends of the longitudinal fold lines 114. The notches are similar to those used in conventional systems and they define flanges 120. Unlike the conventional construction, however, transverse (horizontal in FIG. 3) fold lines 114 also are provided, at the base of each of the flanges 120. In this manner, when constructed, the flanges 120 can be folded relative to the sidewall. As illustrated in FIG. 2, the flanges 120 preferably are folded relative to the sidewall 112 to be perpendicular thereto.

With each of the flanges 120 angled relative to the sidewall, the flanges proximate one, open end 114 of the segment preferably provide a substantially planar surface about the entire perimeter of the opening.

An adhesive 122 preferably is disposed on the substantially planar surface of the flange 120 opposite the sidewall 112, i.e., facing longitudinally away from the segment 110, on a face of the flanges. More particularly, the adhesive 122 preferably is a two-sided adhesive that is adhered on one side to the flange. The other side of the adhesive preferably is covered with a removable covering (not shown) or the like that protects the adhesive until installation, as will be described in more detail below. The adhesive 122 may be applied to both ends of the duct segment 110, or it may be applied on only one end. Several adhesives are well known in the art.

As noted above, the ducts are generally formed by cutting and folding a blank such as that shown in FIG. 3. Accordingly, when the flanges 120, which are situated proximate the edges of the sheet metal blank, are folded back to their substantially perpendicular position, the notches 118 result in substantially square gaps formed at each of the four corners of the open ends of the duct. That is, because of the notches, the flanges form four discrete flanges depending from each of the four sidewalls. While the adhesive 122 may be applied to the four flanges (as either a single piece of adhesive or some larger number of pieces), the inventors have found that it is desirable to instead have a substantially planar surface along the entire periphery of each of the open ends. Specifically, the inventors have found that air may escape through the gaps formed at the corners of the ends of the duct segment 110. Accordingly, and as illustrated in FIG. 4, corner pieces 130 preferably are included in each duct segment in accordance with this invention.

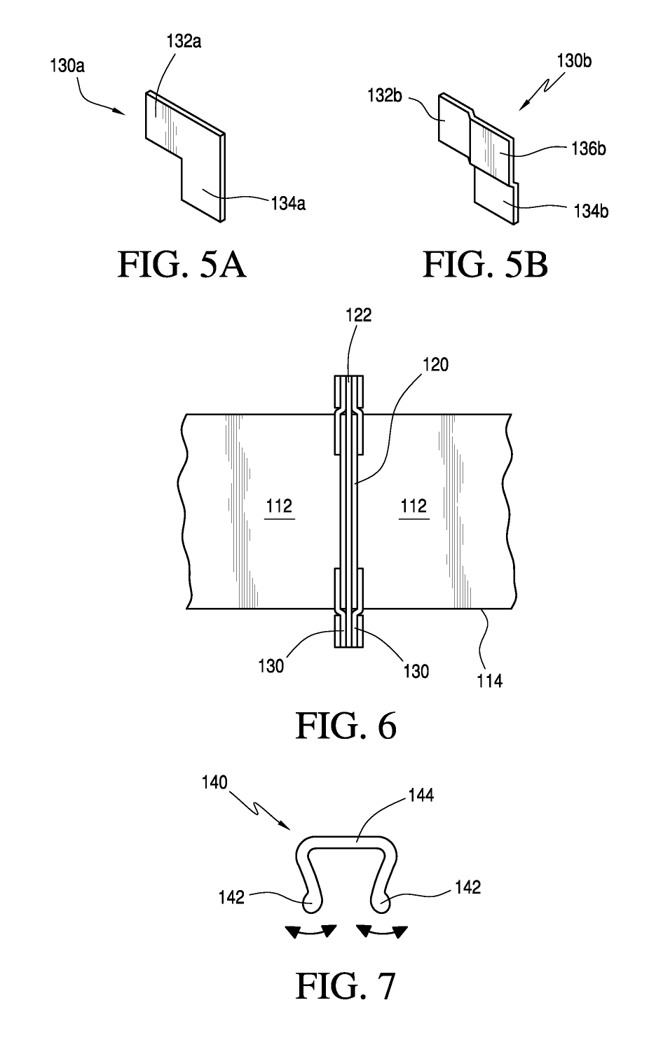

Examples of two corner pieces 130a, 130b that can be used with the invention are illustrated in FIGS. 5A and 5B, respectively. In both embodiments, the corner piece 130a, 130b is generally L-shaped. As illustrated in FIG. 4, such corner pieces 130a, 130b are disposed in the open corners or gaps resulting from the manufacturing process of the ducts. Disposed in this manner, the corner pieces 130a, 130b cooperate with the flanges 120 to form a substantially planar surface around the entire periphery of the open end 114 of the duct segment 110.

Each of the corner pieces 130a, 130b preferably is attached to the duct by being fastened to the flanges 120 proximate a corner of the open end of the duct segment. Any known fastening means may be used to secure the corner piece 122 to the flanges 112, including, but not limited to, rivets, adhesive, screws, welding and the like.

FIG. 5A illustrates the first corner piece 130a. The corner piece 130a has an L-shape, including two substantially perpendicular legs 132a, 134a, a substantially planar front and back, and a substantially uniform thickness. The corner piece 130a may be attached to a side of the flanges proximate the body of the duct segment (as illustrated in FIG. 4) or may be attached to the outward facing side of the flanges 120. If the corner piece 130a is placed on a side of the flanges opposite the body of the duct segment, i.e., on the outward facing side, the thickness of the corner piece 130 preferably is minimized to keep the entire periphery around the open end as planar as possible, because the corner piece 130a will result in an outward step relative to the face of the flanges 120. In another configuration, the legs 132a, 134a of the corner piece may be tapered to have a narrower thickness at ends of the legs and a wider thickness proximate the joint of the legs 132a, 134a. When the corner piece 130a is disposed on a side of the flange nearer the duct, the thickness is less relevant.

When the corner piece 130a is used with the duct segment 110, it will be appreciated that slight steps will exist at the transitions between the corner piece 130a and the flanges 120, regardless of which side of the flanges 20 the corner piece is disposed on. In operation, however, these steps can be compensated for by choosing a thicker adhesive or a more pliable adhesive. More specifically, if the adhesive is allowed to compress when adjacent ducts are pressed together, the slight step between the corner pieces 130a and the flanges 120 will be compensated for by the pliability of the adhesive used to join the adjacent ducts.

In other embodiments, it may not be desirable to have any steps between the corner pieces 130 and the flanges 120. Accordingly, FIG. 5B illustrates a second preferred corner piece 130 that includes two perpendicular legs 132b, 134b meeting at a stepped adhesive-support section 136b. In this embodiment, the legs serve as mounting surfaces for mounting the corner piece 130b to the flange 120, but the stepped section 136b of the corner piece 122b is off-set or stepped relative to the legs. Preferably, the step is sized to correspond to the thickness of the flanges 120. When the legs 132b, 134b of the corner piece 130b are mounted on the backside of the flanges 120, i.e., proximate the sidewall 112, the stepped section 136b will line up with, or lie in the same plane as, the flanges 120 of the duct segment. As should be appreciated, this embodiment of the corner piece provides a more planar periphery about the entire open end 114.

From the foregoing, it is apparent that four corner pieces 130a, 130b will be necessary to create the desired periphery around the open end when the duct has a square or rectangular cross-section. However, it is also anticipated that the periphery can be completed using less than four individual corner pieces. For example, a single square shaped piece may be disposed on the flanges 120 to provide a substantially planar surface for abutting adjacent duct segments. In this example, a single piece would be used to fill the gaps formed in each of the four corners of the open end of the duct. Alternatively, a single piece could be used to incorporate two of the corner pieces, such piece having a substantially U or C-shape. In each of these embodiments, the piece fastened to the flange 120 of the duct could be planar as in the embodiment of the corner piece 122A of FIG. 5A, or could have stepped portions similar to those described in the embodiment of FIG. 5B. Similarly, an embodiment similar to that illustrated in FIG. 5A could be used, but with the legs 132a, 134a being longer, so as to contact the legs 132a, 134a of the corner piece 130a used on an adjacent corner. In this manner, the adhesive would be substantially entirely applied to the corner pieces. Any combinations of the foregoing also may be used.

FIG. 6 illustrates a larger section of a commercial heating and/or cooling system that includes two duct segments such as those shown in FIG. 2. As illustrated in FIG. 6, the ducts preferably are butted together and connected using only the adhesive preapplied to the flange. As noted above, it is preferable that the adhesive be applied only to one end of the duct, such that the end of a first duct having the adhesive is joined to the end of a second duct that is adhesive free. Accordingly, the two-sided adhesive is applied directly to the flanges 120 of the abutting segments. If both ends of each duct segment were to include the two-sided adhesive, the adhesive of the first duct would adhere directly to the adhesive of the second duct. This would be duplicative, however, and likely unnecessary, although it may be required in some applications. According to the present invention, because the faces of the faces of the flanges, i.e., the surfaces of the flanges opposite the sidewalls 112 are substantially planar, adjacent sections of the duct work can be easily abutted, and the adhesive will maintain the connection between the adjacent sections along the entire periphery of the opening. Such an arrangement alleviates the need for conventional fastening methods, such as inserting fasteners through both adjacent ducts. Moreover, the necessity to wrap tape or the like around the duct is eliminated, because a continuous seal is provided around the opening between each of the adjacent sections.

As will be appreciated from the foregoing, the duct segments of the present invention provide substantially planar end faces that are readily abutted to similar faces formed on adjacent duct segments. In operation, an installer situates a segment of the duct in the manner required, exposes the adhesive on the end of the duct, and abuts a second, adjoining duct to the first duct. The inventors have found that this joint conforms with applicable standards now existing in the industry.

The adhesive can be selected to maintain a seal between the adjoining ducts for some predetermined length of time, but it may be desirable to also incorporate a mechanical fastening means. For example, clips may be used that can be slid over adjacent flanges of the abutting ducts. An exemplary clip 140 is illustrated in FIG. 7. The clip 140 includes two spaced apart legs 142 depending from a spine 144. The legs preferably are spring biased in a direction toward each other to apply, a predetermined pressure to maintain the connection between the adjacent flanges. The clip 140 is easily slid over the flanges and requires no tools for installation. In other embodiments, the clip could incorporate a screw or a bolt to apply a pressure. Other clips would be readily conceivable to those of skill in the art, and other clips are known in the art.

As should be understood, even when the clips or some other fastening means such as a screw or the like is used in addition to the adhesive of the present invention, the present invention does not require that a technician wrap the joint with tape. This is particularly troublesome in applications where the ducts are close to either the ceiling or the floor, as it is very difficult to situate tape between the duct and the nearby ceiling or floor.

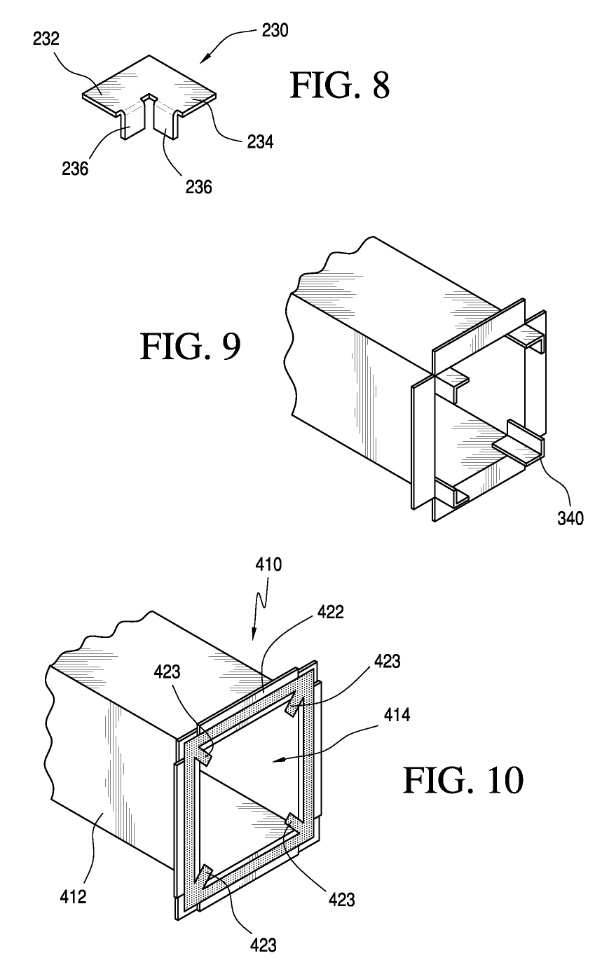

In addition to those modifications discussed above with reference to various features of the present invention, additional modifications also are contemplated. For example, the corner pieces 130 illustrated in FIGS. 5A and 5B as being substantially L-shaped, may also include depending flanges such as is illustrated in FIG. 8. Specifically, that figure illustrates a corner piece 230 having two legs, 232, 234 and flanges 236 depending substantially perpendicularly relative to the planar faces of the piece 230. According to this embodiment, the flanges 236 preferably are used to mount the corner piece to one of the inner and outer surface of the sidewall 112 of the duct segment 110. By mounting the corner piece in this manner, the fastener used to secure the corner piece 230 to the duct segment 110 will not interfere with the substantially planar surface achieved between the corner piece and the flanges. More particularly, there will be no step caused as a result of the fastener when a headed fastener, such as a rivet or a screw is used.

FIG. 9 illustrates another alternative embodiment of the invention. In FIG. 9, a duct segment 310 includes a corner bracket 340 disposed on an inside surface of the sidewall 312 at each of the corners of the duct segment 110. The corner bracket 340 preferably is disposed partially within the duct segment to which it is attached, and projects partially through the opening 114. The corner bracket 340 preferably is provided only on one end of the duct segment. When duct segments are adjoined, they are abutted in the manner such that an end having the corner brackets is inserted into an end of the duct segment without the corner brackets. The corner bracket 340 may provide additional stability to adjoining brackets and provide better alignment, for example, when adhering the two ducts. In addition, the corner brackets preferably assist in closing a gap that can be formed at each of the corners when the pieces are abutted. The corner brackets 340 may be used in connection with corner pieces described previously, or may take the place of such corner pieces. If no corner pieces are used, it may be desirable to use only adhesive along each of the 4 flanges, instead of a unitary adhesive circumscribing the opening 114. The duct segment according to FIG. 9 preferably has the corner brackets on the downstream side flow side of the bracket. Specifically, air flow preferably goes through the duct segment 310 as illustrated by the arrow in that figure. In this manner, and because the corner brackets 340 are fastened to the sidewalls, air does not flow between the sidewall and the corner bracket. The corner brackets may be welded or mechanically fastened using known fasteners.

Yet another embodiment of the invention is illustrated in FIG. 10. As illustrated therein, a duct segment 410 is similar to that described above with regard to the preferred embodiments of the invention. In this embodiment, however, the adhesive 422, which is a unitary piece circumscribing the entire opening 414, includes four tabs 423 for projecting inward at corners of the adhesive 422. The tabs 423 preferably are folded inward, to contact an inside surface of the sidewalls proximate the fold lines 414 between the sidewalls 412. In this manner, the tabs 423 provide an added closure at the gaps formed at each of the corners.

The foregoing embodiments of the invention are representative embodiments, and are provided for illustrative purposes. The embodiments are not intended to limit the scope of the invention. Variations and modifications are apparent from a reading of the preceding description and are included within the scope of the invention. The invention is intended to be limited only by the scope of the accompanying claims.

1. A duct segment comprising:
a continuous sidewall defining a passage terminating at two opposing openings;
a plurality of flanges disposed about at least one of the openings, the flanges extending substantially perpendicularly from the sidewall and forming a substantially planar mounting surface about the opening; and
an adhesive having an inner edge and an outer edge, the adhesive being applied to the mounting surface of all of the plurality of flanges, on a side of the flanges opposite the sidewall, the adhesive completely circumscribing the opening such that the inner edge is arranged relatively closer to the opening and the outer edge is spaced from the inner edge away from the opening, the adhesive being contiguous between the inner edge and the outer edge about the entire periphery of the opening.

2. The duct segment of claim 1, wherein the opposing openings are polygonal in cross section.

3. The duct segment of claim 1, wherein the flange comprises a portion of the sidewall adjacent one of the openings that is folded relative to an adjacent portion of the sidewall.

4. The duct segment of claim 1, further comprising a corner piece disposed proximate at least one of the flanges.

5. The duct segment of claim 4, wherein the corner piece is substantially L-shaped having first and second legs.

6. The duct segment of claim 5, the corner piece further comprising a stepped portion disposed in substantially the same plane as the mounting surface.

7. The duct segment of claim 4, comprising a plurality of corner pieces disposed such that the flanges and the corner pieces circumscribe the opening.

8. The duct segment of claim 1, further comprising at least one corner bracket fixed to the sidewall and extending in a longitudinal direction from the opening past the mounting surface.

9. The duct segment of claim 1, wherein the adhesive is a double-sided adhesive.

10. The duct segment of claim 1, wherein the adhesive is a unitary piece disposed about the periphery of the opening.

11. The duct segment of claim 9, the adhesive further comprising at least one tab deformable with respect to the remainder of the adhesive for fixing on an inner surface of the sidewall.

12. A duct segment comprising:
a sidewall defining an inner volume and terminating at opposing, open ends;
at least one flange associated with each of the open ends, the at least one flange substantially circumscribing the associated open end, extending substantially perpendicularly from the sidewall and having a face directed away from the sidewall; and
an adhesive disposed on the face of the at least one flange associated with one of the open ends, the adhesive having an inner edge proximate the open end and an outer edge spaced from the inner edge on a side opposite the open end, the adhesive completely circumscribing the open end and being contiguous between the inner edge and the outer edge.

13. The duct segment of claim 1, wherein the at least one flange associated with one of the open ends comprises a number of flanges that is equal to a number of sides defined by the sidewall, and wherein a gap is formed between proximate flanges.

14. The duct segment of claim 13, further comprising a corner piece fixed relative to the proximate flanges and disposed in the gap.

15. The duct segment of claim 14, wherein corner pieces are provided in each gap to form a substantially continuous mounting surface comprising the corner pieces and the faces of the proximate flanges.

16. A duct assembly comprising a plurality of duct segments as claimed in claim 12, wherein duct segments are adjoined such that faces of the flanges are arranged facing each other, with the adhesive disposed between the flanges facing each other, the adhesive securing the joined duct segments.

17. The duct assembly of claim 16, further comprising a clip providing a biasing force to sandwich the adhesive between the faces of the abutting duct segments.

18. The duct assembly of claim 16, wherein the adhesive is disposed on the faces of the flanges associated with only one end of each duct segment, such that when assembled, a single adhesive is disposed between the abutting duct segments.

19. A method of assembling a length of duct work comprising:
providing first and second duct segments, each duct segment including a sidewall defining an inner volume and terminating at opposing, open ends; at least one flange associated with each of the open ends, the at least one flange substantially circumscribing the associated open end, extending substantially perpendicularly from the sidewall, and having a face directed away from the sidewall; and an adhesive disposed on the face of the at least one flange associated with one of the open ends, the adhesive having an inner edge proximate the open end and an outer edge spaced from the inner edge on a side opposite the open end, the adhesive completely circumscribing the open end and being contiguous between the inner edge and the outer edge; and
abutting the at least one flange of the first duct segment to the adhesive of the second duct segment to substantially align the inner volumes of the first and second duct segments and to seal the first duct segment to the second duct segment.
